(19) United States
(12) Patent Application Publication
(10) Pub. No.: US 2022/0291947 A1
(43) Pub. Date: Sep. 15, 2022

(54) APPARATUS, SYSTEMS, AND METHODS FOR FACILITATING EFFICIENT HARDWARE-FIRMWARE INTERACTIONS

(71) Applicant: Meta Platforms, Inc., Menlo Park, CA (US)

(72) Inventors: Srikanth Alaparthi, Fremont, CA (US); Harikrishna Madadi Reddy, San Jose, CA (US); Olof Johansson, Belmont, CA (US); Alexander Mastro, San Francisco, CA (US)

(21) Appl. No.: 17/198,028

(22) Filed: Mar. 10, 2021

(51) Int. Cl. G06F 9/48; G06F 3/06

(52) U.S. Cl. CPC G06F 9/485; G06F 3/0655; G06F 3/0604; G06F 3/0673

(57) ABSTRACT

A system for facilitating efficient hardware-firmware interactions may include (i) a plurality of memory registers, (ii) a hardware module that directly reads from and writes to the plurality of memory registers and is configured to interpret a special marker that distinguishes between register write operations and non-register-write operations, and (iii) a firmware module that directs the hardware module to perform operations at least in part by sending the special marker. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for facilitating efficient hardware-firmware interactions.

FIG. 2 is a flow diagram of an exemplary method for facilitating efficient hardware-firmware interactions.

FIG. 3 is a block diagram of a command direct memory access module.

FIG. 4 is a block diagram of a read engine for a command direct memory access module.

FIG. 5 is a block diagram of a write engine for a command direct memory access module.

FIG. 6 is a block diagram of a read engine for a command direct memory access module.

FIG. 7 is a block diagram of a command direct memory access module performing multithreaded operations.

FIG. 8 is an additional block diagram of a command direct memory access module performing multithreaded operations.

FIG. 9 is a flow diagram of a method for a command direct memory access module to execute a terminate command.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION OF EXEMPLARY EMBODIMENTS

In many firmware (FW) controlled system designs, FW prepares the programming sequence and programs hardware (HW) in order to achieve a specific functionality. Preparing this sequence, programming the sequence to HW, waiting for HW completion, and monitoring the HW state for any additional information may involve context switching in FW and cause high latency in the processing time. The latency may become critical and significant in throughput driven designs where multiple HW threads work in pipeline fashion to achieve a common task, such as a transcoder that decodes a video sequence of a particular format and encodes the video sequence in different formats and resolutions.

The present disclosure is generally directed to systems and methods for facilitating efficient hardware-firmware interactions. In order to minimize FW context switching and latency in processing times, the systems described herein offload some of this from FW and implement some of the programming features in HW. In one embodiment, a new HW module, called command direct memory access (CDMA), may be added in the transcoder solution or other hardware configuration. In some examples, a CDMA may support a pointer-to-pointer scheme for basic register programming, a special marker that enables the HW to distinguish between register write operations and special operations (e.g., read, wait, etc.), a wait-for-done command, and/or debug and performance traces. This may enable FW to use dedicated buffers for a programming sequence that is common across frames for a given HW thread. In some embodiments, this system may minimize FW buffer updates (or writes) and/or save command list preparation time.

In some embodiments, the systems described herein may improve the functioning of a computing device by increasing the speed at which the computing device performs operations. Additionally, the systems described herein may improve the fields of computational efficiency and/or video transcoding by improving the efficiency at which computing devices can execute certain command sequences, such as the command sequences used in video transcoding.

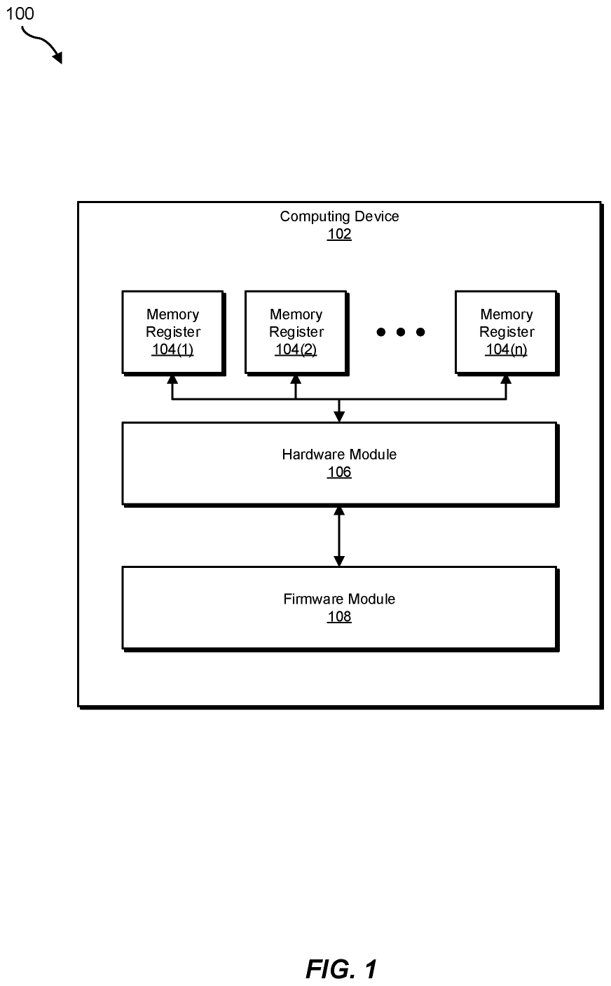

In some embodiments, the systems described herein may facilitate efficient hardware-firmware interaction. FIG. 1 is a block diagram of an exemplary system 100 for facilitating efficient hardware-firmware interaction. In one embodiment, and as will be described in greater detail below, a computing device 102 may be configured with memory registers 104(1) through 104(n). In some embodiments, a hardware module 106 may perform read and/or write operations on memory registers 104(1) through 104(n). In one example, hardware module 106 may be a CDMA that is configured to interpret a special marker that distinguishes between register write operations and non-register-write operations. In one embodiment, computing device 102 may include a firmware module 108 that directs hardware module 106 to perform operations at least in part by sending the special marker. In some embodiments, computing device 102 may include a hardware element configured to execute firmware module 108. Computing device 102 may represent various types of computing devices including but not limited to personal computing devices (e.g., laptops, desktops, smart phones, etc.), servers, embedded computing devices, and/or smart devices.

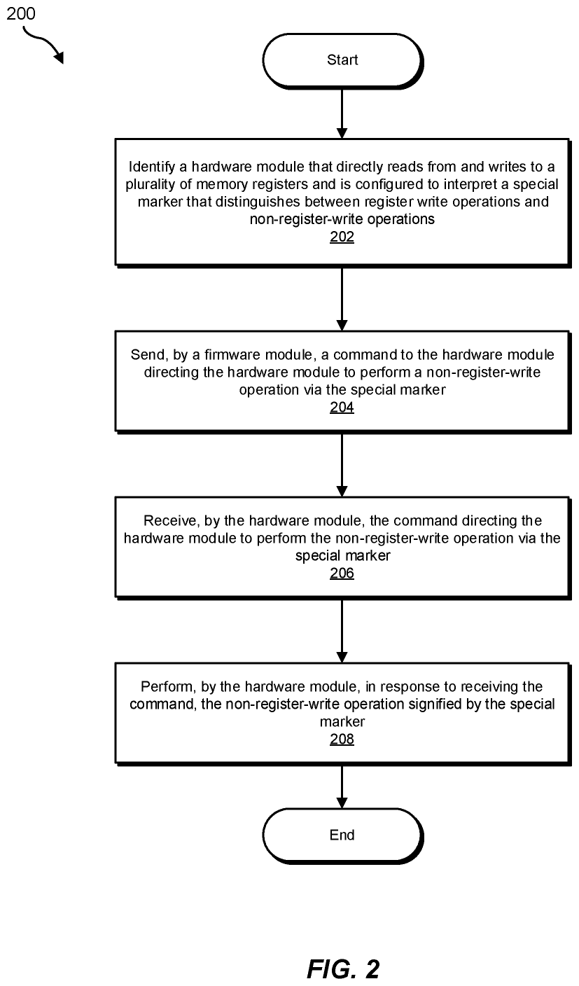

FIG. 2 is a flow diagram of an exemplary method 200 for facilitating hardware-firmware interactions. In some examples, at step 202, the systems described herein may identify a HW module that directly reads from and writes to a plurality of memory registers and is configured to interpret a special marker that distinguishes between register write operations and non-register-write operations. The term “special marker” may generally refer to any string embedded in a message and/or any formatting of a message that is interpreted by a specially configured hardware module (e.g., a CDMA) as a command other than the default command performed by the hardware module (e.g., register write). The special marker may take a variety of forms. For example, the systems described herein may designate a specific register in CDMA control/status register space and use the address of the designated register as the special marker. In some examples, the systems described herein may define specific operation codes (opcodes) that each designate a specific operation, such as wait-for-done, terminate, debug, and so forth. In one embodiment, a 32-bit address field may be split into 28 bits for the address of the designated register and four bits for opcodes. The systems described herein may perform step 202 in a variety of ways. In one example, the systems described herein may identify a CDMA. The term “CDMA” generally refers to any hardware module that is capable of perform register read and write operations and that is configured to interpret a special marker. In some embodiments, a CDMA may manage multiple hardware threads.

At step 204, the systems described herein may send, by a FW module, a command to the HW module directing the HW module to perform a non-register-write operation via the special marker. The term “non-register-write operation” may generally refer to any operation performed by hardware that does not exclusively consist of writing data to a memory register. For example, a non-register-write operation may include a register read operation, a wait-for-done operation, a terminate operation, and/or a debug operation. The systems described herein may perform step 204 in a variety of ways. In one example, FW may send a wait-for-done command to the CDMA. In another example, FW may send a terminate command to the CDMA.

At step 206, the systems described herein may receive, by the HW module, the command directing the HW module to perform the non-register-write operation via the special marker. The systems described herein may perform step 206 in a variety of ways. For example, the CDMA may read the command from a command queue. In some embodiments, the CDMA may check a designated section of memory for commands from FW.

At step 208, the systems describe herein may perform, by the HW module, in response to receiving the command, the non-register-write operation signified by the special marker. For example, the CDMA may read data, wait for a thread to complete, and/or terminate operations. In one example, the CDMA may send debug data to FW. For example, upon receiving a debug command signified by a debug opcode in the special marker, the CDMA may output debugging information into external memory that can be used by FW for performance monitoring, analysis, and/or debugging processes. In another example, the CDMA may receive a wait-for-done command and in response, the CDMA may pause operating until detecting that a hardware thread specified by the wait-for-done command has completed.

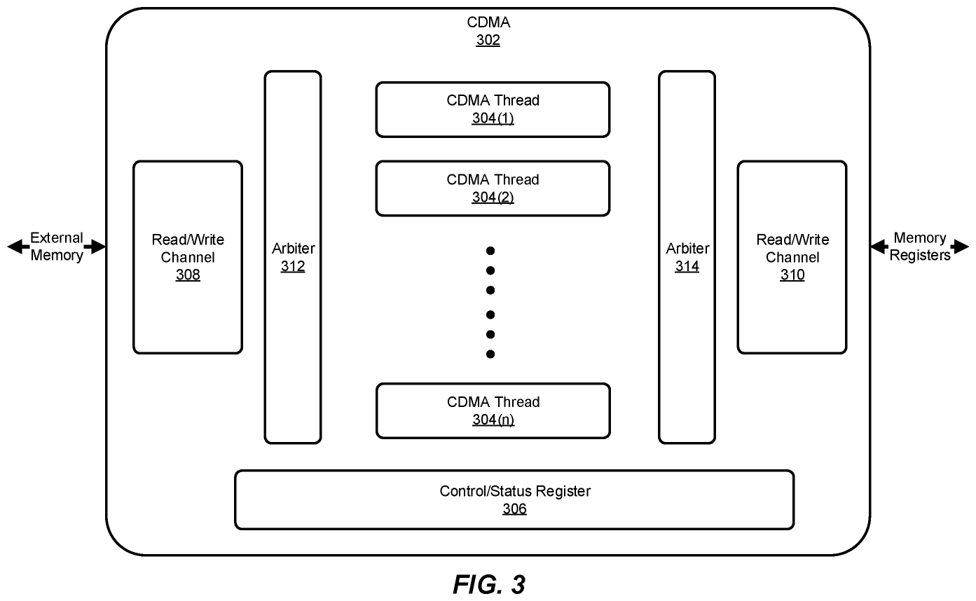

FIG. 3 is a block diagram of an example CDMA 302. In one embodiment, CDMA 302 may include a read/write channel 308 and/or a read/write channel 310. In some examples, read/write channel 308 may use an advanced extensible interface (AXI) communication interface to read data from external memory and/or write data to externa memory. In one example, read/write channel 310 may use an advanced microcontroller bus (AHB) interface to read data from memory registers (e.g., the status register) and/or write data to memory registers. In other embodiments, the systems described herein may use other hardware architecture, interfaces, and/or protocols for write channel 308 and/or read channel 310. In some embodiments, write channel 308 and/or read channel 310 may be capable of executing on multiple threads simultaneously and arbiters 312 and/or 314 may allocate access to write channel 308 and/or read channel 310, respectively. For example, CDMA 302 may be configured to execute CDMA threads 304(1) through 304(n). In one embodiment, CDMA 302 may be configured to execute twelve threads. For example, CDMA 302 may be functioning as a video transcoder and may have twelve threads that each correspond to a different format and/or a different stage of the transcoding process. In some embodiments, CDMA 302 may periodically update a control/status register (CSR) 306 with the current status of CDMA 302. In some embodiments, CDMA 302 may maintain internally the position within each buffer and provide that information at CSR 306. In one example, data in CSR 306 may indicate the address of the current command being executed and/or a pointer in CSR 306 may indicate the position within the current programming sequence buffer. Additionally or alternatively, CDMA 302 may receive instructions from FW via one or more designated registers within CSR 306.

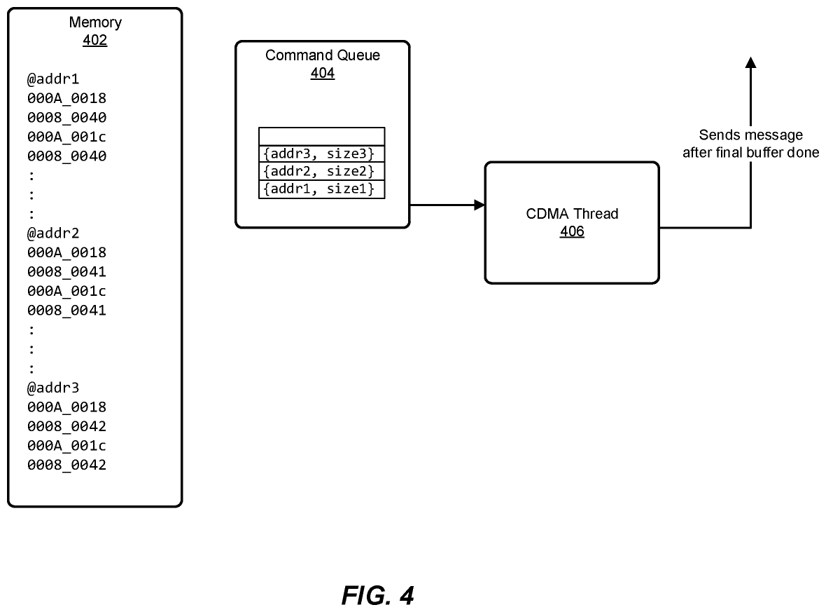

In some embodiments, the systems described herein may support a programming sequence of a thread that is split across multiple physical buffers in memory. For example, as illustrated in FIG. 4, a CDMA may access memory 402 based on a command queue 404 that issues commands to a CDMA thread 406. Memory 402 may represent various types of memory, including but not limited to double data rate synchronous dynamic random-access memory (DDR SDRAM) and/or any other suitable type of random-access memory. In this example, memory 402 may include three different buffers that are prepared by FW for access by one or more CDMA threads. In some embodiments, this may enable FW to store all the common programming sequences in one buffer to use these sequences across frames for a given thread as well as across threads. For example, the frame width and height for a given video sequence may be unchanged across multiple stages of transcoding. Likewise, the debug programming sequence and/or reset/clear mechanisms may be constant across frames. For all such sequences, FW may store each sequence in one dedicated buffer. By storing reused sequences in buffers in memory, the systems described herein may prevent FW from having to re-program the buffers repeatedly.

In one embodiment, FW may provide an address pointer and size for the list of commands stored in command queue 404 and the CDMA may fetch the list of commands via the address pointer and size. In some embodiments, the FW may provide the address pointer and size repeatedly, as the buffer may include instructions that are referenced repeatedly, such as the debug programming sequence, clock sequence, reset sequence, and/or interrupt clear sequence.

In some examples, once the buffers are ready, FW may provide all the pointers to the CDMA through a CSR. In one example, there may be multiple buffers to process, preventing the CDMA from having explicit information about when to send a CDMA interrupt to FW. In one embodiment, the CDMA may provide control to FW to push an enable-interrupt command into the command queue. When this command is received, the CDMA may generate an interrupt after the processing of the corresponding buffer.

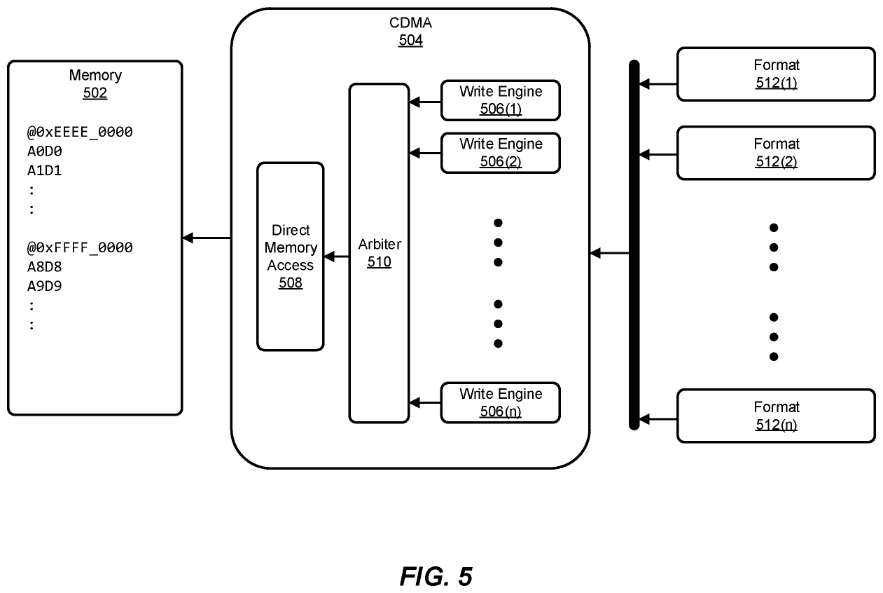

FIG. 5 is a block diagram of an example write engine for a CDMA. In some embodiments, the write engine may only be active if the CDMA is executing register read operations. In one example, the CDMA may issue the read request to memory registers through AHB to collect data, combine the {address, data} pairs to match bus width, then write the data out in bursts to DDR through AXI. In one embodiment, a CDMA 504 may write to a memory 502. In some examples, CDMA 504 may write data in a variety of formats. For example, CDMA 504 may be configured to transcode videos into different formats. In these examples, CDMA 504 may include write engines 506(1) through 506(n) that each correspond to a format from formats 512(1) through 512(n). In some embodiments, write engines 506(1) through 506(n) may have resources allocated by an arbiter 510 that controls access to direct memory access 508. In one embodiment, CDMA 504 may use an AHB interface to read the corresponding registers and then write the address and data pair to memory 502 via an AXI interface. In some examples, FW may provide one write address per thread for a given CDMA session and CDMA 504 may continue to write the data in that location. In some embodiments, each CDMA thread may have one associated write address for FW to program. In some examples, once CDMA 504 receives an opcode indicating that the last data has been received, CDMA 504 may flush out any partial data to memory 502 and/or returns write-done interrupt to FW.

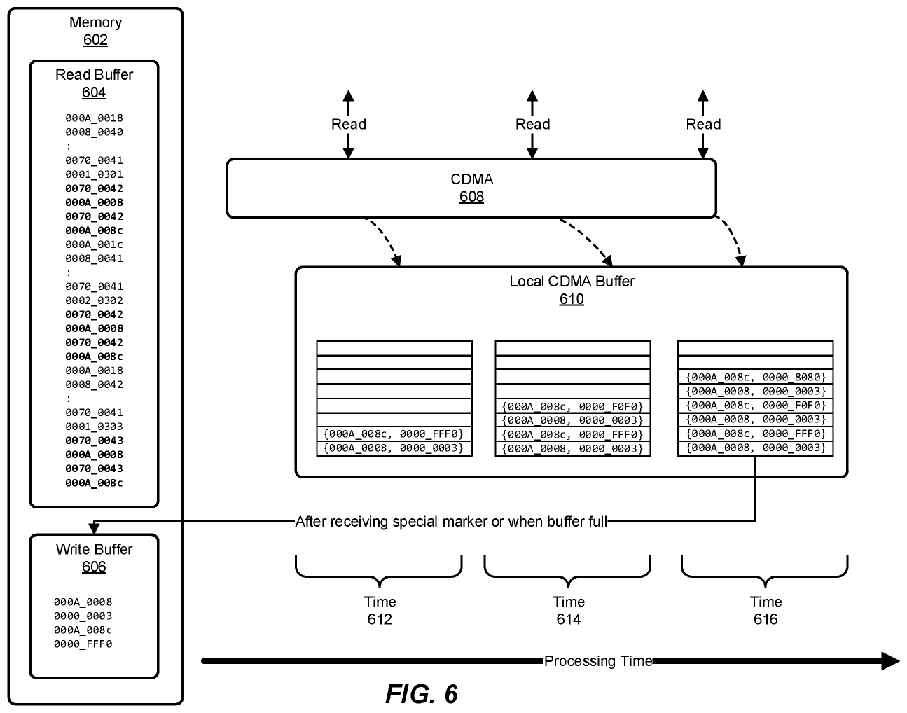

FIG. 6 is a block diagram of a read engine for a CDMA. In one embodiment, a CDMA 608 may read from a read buffer 604 in memory 602 and/or write to a write buffer 606 in memory 602. In some embodiments, CDMA 608 may read from and/or write to a local CDMA buffer 610. For example, CDMA 608 may read and/or process a first set of data at a time 612, a second set of data at a time 614, and/or a third set of data at a time 616. Once local CDMA buffer 610 is full and/or CDMA 608 has received a special marker instructing CDMA 608 to write all data, CDMA 608 may write the data in local CDMA buffer 610 to write buffer 606 in memory 602. In one example, FW may read three registers after each wait-for-done instruction and may finish the session after three frames. In this example, there may be a total of nine register reads and the amount of data written to memory 602 may be 72 bytes.

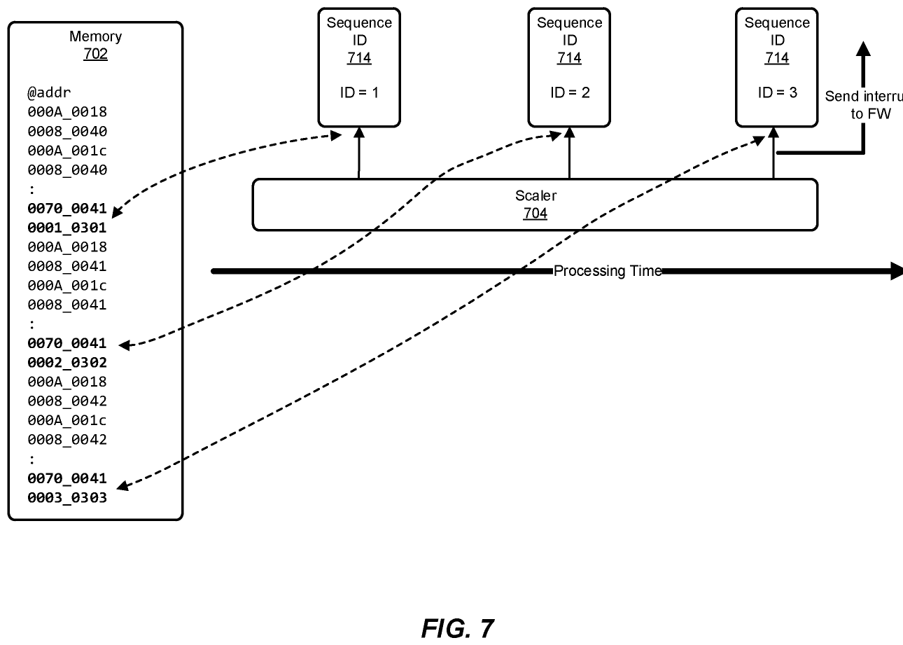

In some embodiments, the systems described herein may use a sequence identifier (ID) inserted in the special marker to facilitate cross thread dependency and/or efficiency within a single thread. In some examples, a sequence ID may be represented as a continuously incrementing eight bit value. For example, as illustrated in FIG. 7, FW may prepare a scalar 704 (e.g., an Xcoder scalar) for processing three frames through a CDMA with a wait-for-done marker between frames. In one example, the scalar thread ID may be three, so the CDMA may use CDMA thread three. In this example, once all the frames are completed, the CDMA may send the final interrupt to FW indicating that processing is done. In some embodiments, each sequence identifier may be incremented for each done command so that other threads may check the sequence identifier to determine the status of the thread. For example, sequence ID 714 for scalar 704 may be initially set to one, increment to two, and then increment to three as each frame is completed. In this example, FW may receive only one interrupt for three frames processed using a CDMA system, reducing the latency compared systems without a CDMA where FW may receive three interrupts, one after each scalar frame is processed.

In some examples, the main challenge of cross thread dependency modeling may be the variable processing times of each thread. Some of the threads may finish faster than others, making the synchronization difficult. In order to solve this problem, the systems described herein may use a sequence ID. For example, the systems described herein may store the sequence ID for each scalar in the corresponding CDMA thread. In this example, when a dependent thread is waiting, the thread may compare the thread's own wait-sequence-ID against the stored value from the master thread and may proceed as long as the wait-sequence-ID is greater than or equal to the stored sequence ID.

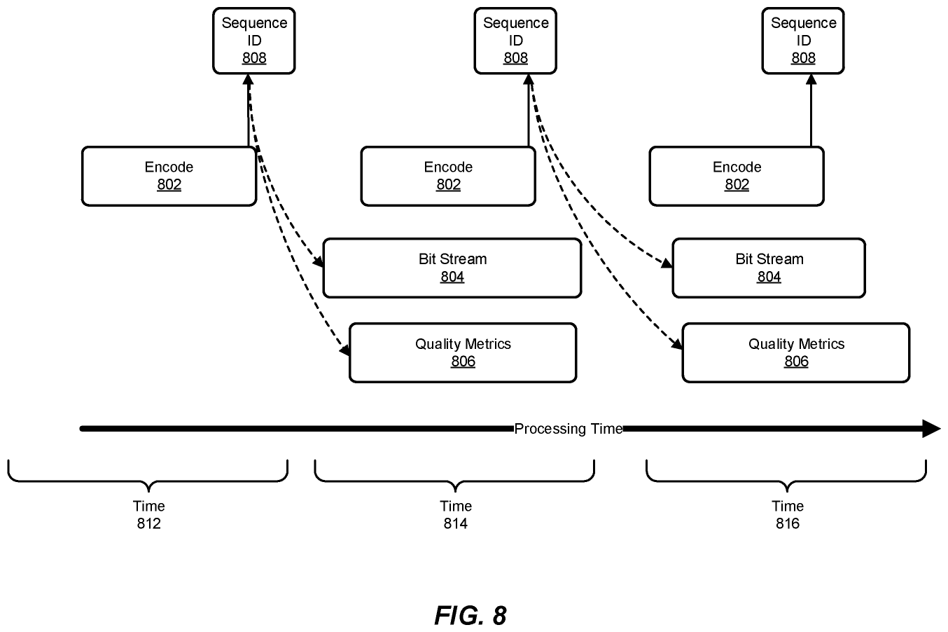

In one example, as illustrated in FIG. 8, a CDMA may handle encode (ENC), bit stream (BS), and/or quality metrics (QM) dependent threads. Each done signal from an ENC thread may trigger the processing of the frame by the BS and QM. For example, at time 812, ENC 802 may finish processing a frame and update a sequence ID 808. Based on this update, at time 814, BS 804 and/or QM 806 may begin processing that frame. Meanwhile, ENC 802 may begin processing a new frame. When ENC 802 finishes processing the new frame and updates sequence ID 808 again, at time 816, BS 804 and/or QM 806 may process that frame while ENC 802 moves on to a new frame. In one embodiment, BS 804 may only start processing a new frame if two conditions are met: BS 804 has finished processing the previous frame and ENC 802 has finished processing the new frame. In some examples, the systems described herein may check the current sequence ID for both BS 804 and ENC 802 to determine whether BS 804 is ready to begin processing a new frame.

In one example, when the CDMA is processing BS 804, the CDMA may identify the wait-for-done marker for ENC 802. The CDMA may internally compare the stored value from ENC 802 to check if it is greater than or equal to the wait-for-done marker and may wait until that condition is met before programming BS 804. In some examples, ENC 802 may not have to wait at each done message for the done to be sampled by all dependent threads. In this example, each thread with variable processing times may not impact other threads.

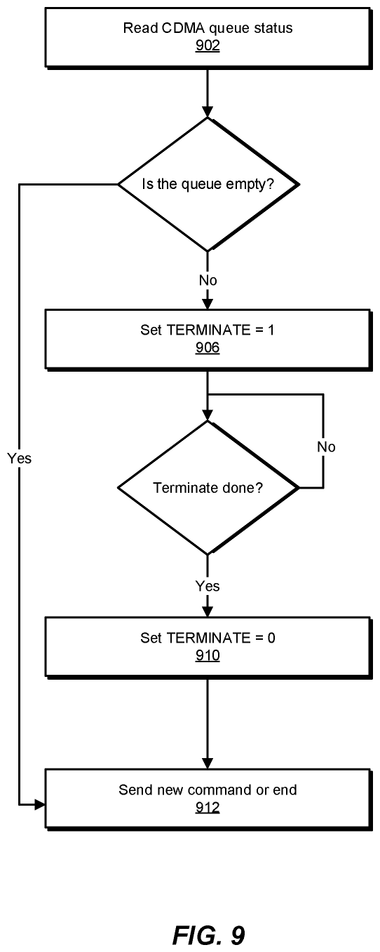

In some embodiments, a CDMA may terminate processing when certain conditions are met. For example, the CDMA may receive a terminate command from FW. FIG. 9 is a flow diagram of an example method for a CDMA to execute a terminate command. After receiving a terminate command, at step 902, the systems described herein may read the CDMA queue status. If the queue is empty, at step 912, the systems described herein may send a new command or end processing. If the queue is not empty, at step 906, the systems described herein may set a terminate bit to equal one. If the terminate is not complete, the systems described herein may wait. For example, the systems described herein may wait for one or more hardware threads to complete. In some embodiments, the systems described herein may drain prefetched data and/or empty the queue. If the terminate is complete, the systems described herein may, at step 910, set the terminate bit equal to zero. In some embodiments, the CDMA may send a message to FW confirming completion of the terminate operation. The systems described herein may then proceed to step 912 and send a new command or end processing.

In some embodiments, a CDMA may timeout under certain conditions. In some examples, between the passes or frames, a CDMA may wait for completion from the corresponding HW thread. In order to recover from any hang scenarios, FW may enable timeout behavior and program a timeout value. Upon reaching the timeout value (e.g., waiting for a hardware thread for an amount of seconds, milliseconds, or other measurement of time that matches the timeout value), a CDMA thread may generate a timeout message to send to FW and wait in the same state until receiving a message from FW. In some examples, FW may continue to wait after receiving the timeout message or may issue a terminate command to the CDMA.

As described above, the systems and methods described herein may improve the efficiency of various computing processes, such as video transcoding, by using a special marker to communicate with a CDMA that receives commands from FW and reads and writes to registers. By storing repeatedly accessed information and command sequences in buffers in memory that can be read by the CDMA via the command queue, the systems described herein may eliminate redundant iterations of programming that same information into buffers by FW in between different sequences. The systems described herein may direct the CDMA via a special marker with different opcodes for different operations, such as debug, terminate, and wait-for-done. Using a wait-for-done command with a sequence ID that specifies a thread may enable the systems described herein to facilitate cross-thread dependency by maintaining and transmitting information about the current status of each thread, enabling threads to wait only for relevant other threads to finish processing rather than having to wait for all threads.

### EXAMPLE EMBODIMENTS

Example 1: A system for facilitating efficient hardware-firmware interactions may include (i) a group of memory registers, (ii) a hardware module that directly reads from and writes to the memory registers and is configured to interpret a special marker that distinguishes between register write operations and non-register-write operations, and (iii) a firmware module that directs the hardware module to perform operations at least in part by sending the special marker.

Example 2: The system of example 1, where the non-register-write operations include at least one of a register read operation, a wait-for-done operation, and/or a debug operation.

Example 3: The system of examples 1-2 may further include an address of a predefined special memory register and an operation code.

Example 4: The system of examples 1-3, where the firmware module prepares a list of commands stored in memory, the firmware module provides at least one address pointer and size for the list of commands to the hardware module, and the hardware module fetches the list of commands via the at least one address pointer and size.

Example 5: The system of examples 1-4, where the firmware module provides, to the hardware module, a plurality of address pointers that each point to a different segment of a single command in the list of commands.

Example 6: The system of examples 1-5, where the hardware module stores the at least one address pointer to a memory register within the plurality of memory registers.

Example 7: The system of examples 1-6, where the firmware module provides the at least one address pointer to the hardware module repeatedly during different points in time.

Example 8: The system of examples 1-7, where the hardware module receives a command to perform a wait-for-done operation, the hardware module pauses operating until detecting that a hardware thread has completed, and the hardware module resumes operating in response to detecting that the hardware thread has completed.

Example 9: The system of examples 1-8, where the command to perform the wait-for-done operation includes a sequence identifier and the hardware module facilitates cross-thread dependency by pausing operating until detecting that the hardware thread specified by the sequence identifier has completed.

Example 10: The system of examples 1-9, where the hardware module receives a command to perform a terminate operation and, in response, the hardware module pauses operating until detecting that at least one hardware thread has completed, drains prefetched data, empties a command queue, and confirms a completion of the terminate operation to the firmware module.

Example 11: The system of examples 1-10, where the hardware module receives a command from the firmware to perform a debug operation and in response, the hardware module writes data to memory that is accessible to the firmware.

Example 12: The system of examples 1-11, where the hardware module stores a timeout value that, when reached, prompts the hardware module to pause operating and send a timeout message to the firmware module.

Example 13: The system of examples 1-12, where the hardware module stores, in at least one memory register within the plurality of memory registers, a current status of the hardware module.

Example 14: A computer-implemented method for facilitating efficient hardware-firmware interactions may include (i) identifying a hardware module that directly reads from and writes to a plurality of memory registers and is configured to interpret a special marker that distinguishes between register write operations and non-register-write operations, (ii) sending, by a firmware module, a command to the hardware module directing the hardware module to perform a non-register-write operation via the special marker, (iii) receiving, by the hardware module, the command directing the hardware module to perform the non-register-write operation via the special marker, and (iv) performing, by the hardware module, in response to receiving the command, the non-register-write operation signified by the special marker.

Example 15: The computer-implemented method of example 14, where the non-register-write operation includes a register read operation and the hardware module performs the register read operation by reading data from a memory register within the plurality of memory registers.

Example 16: The computer-implemented method of examples 14-15, where (i) the non-register-write operation includes a wait-for-done operation, (ii) the hardware module performs the wait-for-done operation by pausing operating until the hardware module detects that a hardware thread has completed, and (iii) the hardware module resumes operating in response to detecting that the hardware thread has completed.

Example 17: The computer-implemented method of examples 14-16, where the computer-executable instructions cause the physical processor to the command to perform the wait-for-done operation includes a sequence identifier and the hardware module facilitates cross-thread dependency by pausing operating until detecting that the hardware thread specified by the sequence identifier has completed.

Example 18: The computer-implemented method of examples 14-17, where the non-register-write operation includes a debug operation and the hardware module performs the debug operation by writing data to memory that is accessible to the firmware.

Example 19: The computer-implemented method of examples 14-18, where the non-register-write operation includes a terminate operation and the hardware module performs the terminate operation by (i) pausing operating until detecting that at least one hardware thread has completed, (ii) draining prefetched data, (iii) emptying a command queue, and (iv) confirming a completion of the terminate operation to the firmware module.

Example 20: An apparatus may include (i) a plurality of memory registers, (ii) a hardware module that directly reads from and writes to the plurality of memory registers and is configured to interpret a special marker that distinguishes between register write operations and non-register-write operations, and (iii) a hardware element configured to execute a firmware module that directs the hardware module to perform operations at least in part by sending the special marker.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive image data to be transformed, transform the image data into a data structure that stores user characteristic data, output a result of the transformation to select a customized interactive ice breaker widget relevant to the user, use the result of the transformation to present the widget to the user, and store the result of the transformation to create a record of the presented widget. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a plurality of memory registers;
a hardware module that:
directly reads from and writes to the plurality of memory registers; and
is configured to interpret a special marker that distinguishes between register write operations and non-register-write operations; and
a firmware module that directs the hardware module to perform operations at least in part by sending the special marker.

2. The system of claim 1, where the non-register-write operations comprise at least one of:
a register read operation;
a wait-for-done operation; or
a debug operation.

3. The system of claim 1, wherein the special marker comprises an address of a predefined special memory register and an operation code.

4. The system of claim 1, wherein:
the firmware module prepares a list of commands stored in memory;
the firmware module provides at least one address pointer and size for the list of commands to the hardware module; and
the hardware module fetches the list of commands via the at least one address pointer and size.

5. The system of claim 4, wherein the firmware module provides, to the hardware module, a plurality of address pointers that each point to a different segment of a single command in the list of commands.

6. The system of claim 4, wherein the hardware module stores the at least one address pointer to a memory register within the plurality of memory registers.

7. The system of claim 4, wherein the firmware module provides the at least one address pointer to the hardware module repeatedly during different points in time.

8. The system of claim 1, wherein:
the hardware module receives a command to perform a wait-for-done operation;
the hardware module pauses operating until detecting that a hardware thread has completed; and
the hardware module resumes operating in response to detecting that the hardware thread has completed.

9. The system of claim 8, wherein:
the command to perform the wait-for-done operation comprises a sequence identifier; and
the hardware module facilitates cross-thread dependency by pausing operating until detecting that the hardware thread specified by the sequence identifier has completed.

10. The system of claim 1, wherein:
the hardware module receives a command to perform a terminate operation; and
in response, the hardware module:
pauses operating until detecting that at least one hardware thread has completed;
drains prefetched data;
empties a command queue; and
confirms a completion of the terminate operation to the firmware module.

11. The system of claim 1, wherein:
the hardware module receives a command from the firmware to perform a debug operation; and
in response, the hardware module writes data to memory that is accessible to the firmware.

12. The system of claim 1, wherein the hardware module stores a timeout value that, when reached, prompts the hardware module to:
pause operating; and
send a timeout message to the firmware module.

13. The system of claim 1, wherein the hardware module stores, in at least one memory register within the plurality of memory registers, a current status of the hardware module.

14. A computer-implemented method comprising:
identifying a hardware module that:
directly reads from and writes to a plurality of memory registers; and
is configured to interpret a special marker that distinguishes between register write operations and non-register-write operations;
sending, by a firmware module, a command to the hardware module directing the hardware module to perform a non-register-write operation via the special marker;
receiving, by the hardware module, the command directing the hardware module to perform the non-register-write operation via the special marker; and
performing, by the hardware module, in response to receiving the command, the non-register-write operation signified by the special marker.

15. The computer-implemented method of claim 14, wherein:
the non-register-write operation comprises a register read operation; and
the hardware module performs the register read operation by reading data from a memory register within the plurality of memory registers.

16. The computer-implemented method of claim 14, wherein:
the non-register-write operation comprises a wait-for-done operation;
the hardware module performs the wait-for-done operation by pausing operating until the hardware module detects that a hardware thread has completed; and
the hardware module resumes operating in response to detecting that the hardware thread has completed.

17. The computer-implemented method of claim 16, wherein:
the command to perform the wait-for-done operation comprises a sequence identifier; and
the hardware module facilitates cross-thread dependency by pausing operating until detecting that the hardware thread specified by the sequence identifier has completed.

18. The computer-implemented method of claim 14, wherein:
the non-register-write operation comprises a debug operation; and
the hardware module performs the debug operation by writing data to memory that is accessible to the firmware.

19. The computer-implemented method of claim 14, wherein:
the non-register-write operation comprises a terminate operation; and
the hardware module performs the terminate operation by:
pausing operating until detecting that at least one hardware thread has completed;
draining prefetched data;
emptying a command queue; and
confirming a completion of the terminate operation to the firmware module.

20. An apparatus comprising:
a plurality of memory registers;
a hardware module that:
directly reads from and writes to the plurality of memory registers; and
is configured to interpret a special marker that distinguishes between register write operations and non-register-write operations; and
a hardware element configured to execute a firmware module that directs the hardware module to perform operations at least in part by sending the special marker.
